(19) United States
(12) Patent Application Publication
(10) Pub. No.: US 2021/0127668 A1
(43) Pub. Date: May 6, 2021

(54) RESIDUAL SPORICIDAL SURFACE DISINFECTANT

(71) Applicant: Microban Products Company, Huntersville, NC (US)

(72) Inventors: Gina Parise Sloan, Statesville, NC (US); Kenneth Clay Wheless, Indian Trail, NC (US)

(21) Appl. No.: 17/086,780

(22) Filed: Nov. 2, 2020

Related U.S. Application Data
(60) Provisional application No. 62/930,215, filed on Nov. 4, 2019.

(51) Int. Cl. A01N 25/34; A01N 31/02; A01N 59/00; A01N 33/12; A01N 43/40; A01N 37/10; A01N 37/04; A01N 37/06

(52) U.S. Cl. CPC A01N 25/34; A01N 31/02; A01N 59/00; A01N 37/06; A01N 43/40; A01N 37/10; A01N 37/04; A01N 33/12

(57) ABSTRACT

A residual sporicidal disinfectant composition(s) is provided. The residual sporicidal disinfectant composition comprises an encapsulated oxidative chemistry. Alternatively, the residual sporicidal disinfectant composition comprises a non-oxidative chemistry.

### CROSS-REFERENCE TO RELATED APPLICATIONS

This application claims priority from U.S. Provisional Patent Application No. 62/930,215, filed on Nov. 4, 2019, in the United States Patent and Trademark Office. The disclosure of which is incorporated herein by reference in its entirety.

### FIELD OF THE INVENTION

The present invention relates to a disinfectant for spores, more particularly to a residual disinfectant for spores.

### BACKGROUND OF THE INVENTION

Bacterial spores are the most difficult form of microorganisms to kill or inactivate according to the Spaulding Classification system. The Spaulding Classification system which was developed in the 1950s defined minimum levels of disinfection (or sterilization). To address spores, sporicidal disinfectants are utilized to kill or inactivate these difficult microorganisms and all others on hard non-porous surfaces. Spores of bacterial agents are known pathogens and have spread disease throughout the centuries, most recently even as bioterrorist agents. A new pathogen of concern is Clostridium difficile which exists in spore form on surfaces. C. difficile exists on surfaces for months and has been demonstrated to be passed via a surface to person transmission route. This is also true for other organisms that exists as spores, such as Bacillus species that are a public health concern.

Current disinfection of spores, such as those formed by C. difficile, rely heavily on oxidative technologies. These technologies degrade rapidly under environmental conditions by reacting with atmospheric oxygen. As such, following disinfection, surfaces can easily become re-contaminated with bacterial spores from the environment, patients, healthcare workers, asymptomatic carriers, among others.

Therefore, there is a need for a disinfectant providing long lasting protection to inanimate surfaces, specifically as it relates to spores. A solution is needed to stop the chain of transmission of spores via the surface driven route thereby providing an overall public health benefit that is lacking in the market today.

### SUMMARY OF THE INVENTION

The present invention relates to a residual sporicidal disinfectant composition.

In an embodiment of the invention, a residual sporicidal disinfectant composition is provided. The residual sporicidal disinfectant composition comprises an encapsulant containing an oxidative chemistry.

In an embodiment of the invention, a residual sporicidal disinfectant composition is provided. The residual sporicidal disinfectant composition comprises a non-oxidative chemistry.

In an embodiment of the invention, a method of treatment is provided. The method of treatment comprises applying a residual sporicidal disinfectant composition to a surface, wherein the residual sporicidal disinfectant composition comprises an encapsulated oxidative chemistry.

In an embodiment of the invention, a method of treatment is provided. The method of treatment comprises applying a residual sporicidal disinfectant composition to a surface, wherein the residual sporicidal disinfectant composition comprises a non-oxidative chemistry.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

The present invention is directed to a composition and method for providing extended surface protection from spores of bacterial agents. Thus, the present invention provides a surface disinfectant having a residual sporicidal property.

In an embodiment of the invention, the composition and method of the present invention uses encapsulation of an oxidative chemistry or technology for sporicidal disinfection. Examples of such oxidative chemistry include, but are not limited to, peracetic acid, acidified hydrogen peroxide, bleach, hypochlorous acid, and combinations thereof.

In an embodiment of the invention, the composition and method use a non-oxidative chemistry or technology for sporicidal disinfection. Examples of non-oxidative chemistry include, but are not limited to, germinants, spore coat penetration proteins, spore coat degradation chemistries, and any of the foregoing in combination with a traditional biocide. A traditional biocide can be selected from non-oxidative chemistries including, but not limited to, quaternary ammonium compounds, metal oxides, zinc pyrithione, sodium pyrithione, fatty acids, benzoates, citrates, sorbates, or any combination thereof, for sporicidal disinfection.

In a preferred embodiment of the invention, the composition is sporicidal without being surface corrosive.

The non-oxidative approach of the invention combines ways to degrade a spore coat with a traditional biocide and/or an encapsulated oxidative technology.

It is contemplated and within the scope of the present invention that these method or methods of the invention can be used alone or in combination. In certain scenarios, it may be optimal to combine one or more of the methods described herein together.

In an embodiment of the invention, a method is provided, The method comprises encapsulating an oxidative chemistry or technology to create a barrier between an active chemistry and the environment. By forming a capsule barrier with an encapsulant, the capsule barrier protects and prevents reaction of the oxidative chemistry with atmospheric oxygen and therefore allows for elongated survival on surfaces.

In accordance with the present invention, multiple release mechanisms can be applied. In one such release mechanism, the capsule itself is slowly degradable under atmospheric conditions, thereby creating a time release system. As the capsule slowly dissolves, the capsule creates leaky pores that allow the steady release of an active onto the surface. The active is either the oxidative or non-oxidative chemistry as described above.

Continued release of the active provides sustained inactivation of new spores on the surface.

In another such release mechanism, a capsule is created such that the capsule ruptures when a physical force is applied to the surface. For example, when a surface is touched by an asymptomatic carrier, the carrier would deposit spores from their skin onto the surface and concomitantly rupture capsules in the vicinity of the newly deposited spores. In this manner, the surface is protected in the specific area that needs protected with the active remaining dormant on other areas.

Additionally, a mixture of capsules with varying degrees of thickness can be utilized. The varying degrees of thickness provide sustained surface protection. For example, it is contemplated that and within the scope of the invention that a small portion of the capsules would rupture with the first touch or encounter, but additional capsules remain to provide additional protection for the following touch or encounter.

As discussed herein, the spore form of microbes is extremely difficult to kill in comparison to the vegetative version of the same microbe. A spore coat protects the microbe from extreme environmental conditions, such as desiccation, chemical exposure, heat, and cold. Disruption of the spore coat to either expose the core or force germination drastically alters the susceptibility to disinfectant chemistries.

For instance, C. difficile spores are not susceptible to quaternary ammonium chlorides, a common disinfectant chemistry. However, vegetative (actively growing) cells of C. difficile are susceptible to typical disinfectant chemistries, such as quaternary ammonium chloride. Germination chemistries typically work slowly and are therefore not preferred for immediate disinfection. However, germination chemistries are specifically suited to prolonged surface protection. Additionally, germination chemistries will not inherently remain on the surface and are not inherently biocidal in nature.

In an embodiment of the invention, one or more of these chemistries are formulated with both a binding system and a biocidal agent. For instance, if a contaminated healthcare worker touched a surface and deposited spore, the germination chemistry would force an opening of the spore coat and the biocidal chemistry would kill the exposed cell. The binding component allows this to occur over multiple touches. Thus, the combination of one or more of germination chemistry, biocidal agent, and binding component together provide extended or residual protection of surfaces against spores.

The spore coats of multiple organisms are known. Compounds, such as enzymes, exist that are capable of degrading specific proteins within the spore coat. The degradation of the proteins causes the spore to be leaky in nature, allowing chemistry into the internal portion of the spore. The combination of the targeted spore degradation compounds with biocidal compounds can create an effective means of immediately inactivating the spore outside of the traditional oxidative chemistries that are available to date.

Oxidative chemistries may create compatibility issues with surfaces by causing corrosion and disruption of physical properties of the surface. As such, it may be preferred that a sporicidal product be non-oxidative in nature. The formulation(s) of the present invention allow for a non-oxidative sporicidal product to be utilized for immediate disinfection.

In addition to the above, the spore degrading compound can be bound to the surface along with a biocidal component to provide extended protection. This can be accomplished via a film forming agent or via a binding chemistry. Additionally, most spore degrading compounds require specific conditions in which to remain active. The formulary components to create a dried buffering system can be added to the formulation to ensure that the spore degrading compound remains active over time. For example, a contaminated piece of equipment may come into contact with the surface, thus depositing spores. The surface would be cleaned with the non-oxidative formulation, to kill any immediate spores on the surface. The binding chemistry is used to bind the spore degrading compound and the biocidal compound to the surface, ensuring the correct environmental conditions exist for activity of the spore degrading compound. When the contaminated piece of equipment touches the surface following cleaning, the contaminating spores are inactivated by the retained components of the initial formulation.

Application of the surface disinfectant formulation may occur by a ready to use spray bottle, pour top, gallon bottle, concentrate, among other dispensers. Additionally, the formulation may be applied to a surface via a wipe, roller, foam, or other applicator.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A residual sporicidal disinfectant composition comprising:
an encapsulant containing an oxidative chemistry.

2. The residual sporicidal disinfectant composition according to claim 1, wherein the oxidative chemistry is selected from the group consisting of peracetic acid, acidified hydrogen peroxide, bleach, hypochlorous acid, and a combination thereof.

3. The residual sporicidal disinfectant composition according to claim 1, further comprising a biocide.

4. The residual sporicidal disinfectant composition according to claim 3, wherein the biocide is selected from the group consisting of a quaternary ammonium compound, metal oxide, zinc pyrithione, sodium pyrithione, fatty acid, benzoate, citrate, sorbate, and a combination thereof.

5. The residual sporicidal disinfectant composition according to claim 1, further comprising a binding component.

6. The residual sporicidal disinfectant composition according to claim 1, wherein the residual sporicidal disinfectant composition has a sporicidal residual disinfectant property.

7. The residual sporicidal disinfectant composition according to claim 1, wherein the composition is sporicidal without being surface corrosive.

8. The residual sporicidal disinfectant composition according to claim 1, wherein the residual sporicidal disinfectant composition is in a form of a capsule.

9. A residual sporicidal disinfectant composition comprising:
a non-oxidative chemistry.

10. The residual sporicidal disinfectant composition according to claim 9, wherein the non-oxidative chemistry is selected from the group consisting of a germinant, a spore coat penetration protein, a spore coat degradation chemistry, and a combination thereof.

11. The residual sporicidal disinfectant composition according to claim 9, further comprising a biocide.

12. The residual sporicidal disinfectant composition according to claim 11, wherein the biocide is selected from the group consisting of a quaternary ammonium compound, metal oxide, zinc pyrithione, sodium pyrithione, fatty acid, benzoate, citrate, sorbate, and a combination thereof.

13. The residual sporicidal disinfectant composition according to claim 9, further comprising a binding component.

14. The residual sporicidal disinfectant composition according to claim 9, wherein the residual sporicidal disinfectant composition has a sporicidal residual disinfectant property.

15. The residual sporicidal disinfectant composition according to claim 9, wherein the composition is sporicidal without being surface corrosive.

16. A method of treatment comprising:
applying a residual sporicidal disinfectant composition to a surface, wherein the residual sporicidal disinfectant composition comprises an encapsulated oxidative chemistry.

17. The method according to claim 16, wherein the oxidative chemistry is selected from the group consisting of peracetic acid, acidified hydrogen peroxide, bleach, hypochlorous acid, and a combination thereof.

18. A method of treatment comprising:
applying a residual sporicidal disinfectant composition to a surface, wherein the residual sporicidal disinfectant composition comprises a non-oxidative chemistry.

19. The method according to claim 18, wherein the non-oxidative chemistry is selected from the group consisting of a germinant, a spore coat penetration protein, a spore coat degradation chemistry, and a combination thereof.
